(19) United States
(12) Patent Application Publication
(10) Pub. No.: US 2005/0051171 A1
(43) Pub. Date: Mar. 10, 2005

(54) Nose breathing mask for a medical patient; and method

(76) Inventor: Jamie Lee Booth, Fresno, CA (US)

Correspondence Address: Jamie Lee Booth, 474 S. Clovis Ave. # 103, Fresno, CA, 93727, US

(21) Appl. No.: 10/369,743

(22) Filed: Sep. 10, 2003

(51) Int. Cl. A62B 7/10; A62B 18/02

(52) U.S. Cl. 128/206.18

(57) ABSTRACT

A medical apparatus and method for medical patients that suffer from Sleep Apnea. A breathing mask that fits comfortably over a nose area. Because a mask is shaped to a face, it is less bulky and cumbersome over the nose area. Inside a shell of a mask, towards a patients' face, is a silicone wax lining that is on the inner rim of a shell and parameters to enclose a nose as a seal. A silicone wax substance is novel to a device because of its ability to retain a form it has been molded into. A silicone wax lining around a nose allows a patient to form and mold a substance against a face and provide an air-tight seal. A single strap is used to fasten and secure a mask to a face. Tabs or buckle can be used to fasten a strap.

### FIELD OF INVENTION

My invention pertains to a medical apparatus in the field of sleep medicine. This apparatus is specifically designed for medical patients who have a condition known as Sleep Apnea. This condition is also known as Sleep Disorder Breathing (SDB) and involves cessation of breathing for at least 10 seconds during sleep. The symptoms that are experienced are daytime somnolence, morning headaches, intellectual deterioration, and disorientation, just to name a few. Many different aspects can contribute to or cause this life threatening condition. Tissue blocking the airway such as the tongue, tonsils, and or adenoids are categorized in the obstructive type of apnea. These tissues are the most common causes of obstructive apnea. The flaccid tissue in the airway blocks the air from reaching the lungs, similar to a clogged drain. The vibration of these tissues is the air trying to get past the blockage. This melody can be identified as snoring. A complete tissue occlusion or collapsed airway will prevent airflow. The body tends not to function appropriately without oxygen. If an arousal occurs, this can be identified as a snort, gasp, or grunt and is the bodys' attempt to restore or resume a breathing pattern. Briefly upper airway muscle tone is restored and breathing is resumed until sleep onset occurs. The obstructive process will then repeat itself. The longer this condition goes untreated, the slower the brain is to respond to then repeat itself. The longer this condition goes untreated, the slower the brain is to respond to the apnea. If left untreated, Sleep Apnea can result in death. Many links between Sleep Apnea and other health related issues have been made.

### BACKGROUND OF THE INVENTION

Sleep Apnea has been recognized since the early 1950's and was previously known as Pickwickian Syndrome. The first CPAP (continuous positive airway pressure) mask was not designed until 1978. The past and present problems of the current art are many. Fairly new to medicine, the available art tends to be heavy, bulky, cumbersome, difficult, as well as awkward to put on and take off. The current art tends to be uncomfortable, unattractive and expensive to manufacture. Patients are unable to make even the slightest move without creating an annoying air leak that comes from the nose mask. Sometimes this is accompanied by a squeal as it aerates their partners face. Many users have complained of a claustrophobic sensation while wearing such devices. Appearance and comfort directly effect patient compliance. Patients are sensitive about their sleep issues. The improvements I have made in comfort, cost, function and appearance is a benefit to all.

### DESCRIPTION OF PRIOR ART

Although there are numerous masks on the market; they all lack comfort, flexibility, and are difficult to use. Some patients find them difficult to assemble as well. Many mask users' complain of panic, anxiety, and a feeling of suffocation. This can be caused by the direct weight of the assembly on their face, as well as improper fitting, and poor designs. Pressure sores and facial irritation from ill-fitting masks are common. This intolerable discomfort effects many and must be endured every night of their lives. Many patients refuse to wear their CPAP masks and discontinue use of CPAP altogether. This response to treatment is obviously undesirable and ill-advised. If one night of therapy is missed, the body will react as though it were never treated. CPAP is the most effective way to treat Sleep Apnea (SDB). My profession as a RRT and NPSGT(Sleep Therapist) gave me insight and hands on for the cost-effective, light-weight, attractive, and effective development of my nose breathing mask.

### SUMMARY OF THE INVENTION

My invention is a nose breathing mask which is used in Continuous Positive Airway Pressure (CPAP) devices. A mask device is an apparatus for providing CPAP though an air tube/hose to a medical patient.

A nose mask comprising of an outer shell that covers a users' nose, a silicone wax seal lining substance around an outer shell, which touches a users face area to provide a seal around a mask, helping prevent air from leaking around a mask.

A hose connector attaches a mask to provide air/oxygen to a user. A nose mask is provided with strap means for securing a mask to a user's head. A users' eyeglasses can be secured with a detachable clip that is positioned at the top of a mask, at a bridge of a nose. A thin aluminum strip on a nose mask which faces away from a user's face is also present.

The substance used for a outer shell of a nose mask is polyurethane material, utilizing a shore in the area of 60 to 70. The shore of a substance is critical to use a nose mask because at a shore of 60 to 70, the hardness of a substance allows a shell to mold or contour to a users' face. Based on the ability of a shell to contour to a users' face, a mask is less bulky and cumbersome. A silicone wax lining substance that is around an outer shell which touches a user's face and boarders around a user's nose. The silicone wax seal lining is novel to a device because of its ability to form to numerous facial features and maintain form once it is molded or contoured to a specific user and provides a comfortable seal. The silicone wax lining is non-removable from the nose mask. A silicone wax lining substance that is around an outer shell which touches a user's face and boarders around a user's nose also has a thin backing with a non-latex adhesive which provides a barrier between silicone-wax and a user's skin. The thin membrane backing could be a substance made by 3M known as “TEGADERM”. “TEGADERM” is a hypoallergenic thin membrane backing with a non-latex adhesive. The thin membrane is non-removable from the nose mask. A user is able to secure a mask to a head via a strap means that goes across a user's cheek bones and under ears. The user attaches a strap to opposing sides of the mask via a hook and loop means such as “VELCRO”. A “VELCRO” tab, which can be of any known shape but is shown in the drawings as a circular shape, on each side of the mask allows for ease of securing a strap to a mask. This versatility accommodates a user to use either hand for attaching a strap to a mask. The “VELCRO” tab allows for easy removal and replacement of a mask without readjustment of the straps or requiring numerous tasks to secure a mask to a face of a user. The strap consists of a common material used by most CPAP masks. It could be a lycra-spandex mixture of fabric.

A user is able to secure a mask to a head via a strap means that goes across a user's cheek bones and under ears. The user attaches a strap to opposing sides of the mask via a hook and loop means such as “VELCRO”. A “VELCRO” tab, which can be of any known shape but is shown in the drawings as a circular shape, on each side of the mask allows for ease of securing a strap to a mask. This versatility accommodates a user to use either hand for attaching a strap to a mask. The “VELCRO” tab allows for easy removal and replacement of a mask without readjustment of the straps or requiring numerous tasks to secure a mask to a face of a user. The strap consists of a common material used by most CPAP masks. It could be a lycra-spandex mixture of fabric.

Another important and unique feature of my mask is the option for a patient to wear eyeglasses for reading or watching TV while wearing my mask. The eyeglasses can be attached to my mask by means of a removable clip, positioned at the bridge of a nose. The material used for a clip such as polyurethane with a shore of 60-70, is the same used for an outer shell of a mask. The thin aluminum strip on a nose mask lies across a bridge of a nose. This strip allows a user to pinch the strip against a nose providing a more snug fit, if desired.

The thin aluminum strip on a nose mask lies across a bridge of a nose. This strip allows a user to pinch the strip against a nose providing a more snug fit, if desired.

A hose connector has an exhalation port that is raindrop-shaped. A respiratory hose connector is unique in a raindrop-shaped exhalation port (can be annular swivel adaptor) that snaps onto an outer shell mask. A hose connector with two open ends. An exhalation port prevents CO2 build-up by allowing exhalation to expel through the port. A second opening is at the other end of a hose to attach to a CPAP machine or gas canister.

### BRIEF DESCRIPTION OF DRAWING

FIG. 1 is an isometric view of a nose breathing mask with an aluminum strip across the bridge. An eyeglass clip that is detachable is directly above the strip. The harness is shown.

FIG. 2 is a front elevated view of the same nose breathing mask of FIG. 1.

FIG. 3 is a right side elevational view of the same nose breathing mask as in FIG. 2. The inside cushion/sealant and “Velcro” tabs are also visible from this view. The left side is an identical view.

FIG. 4 is a rear elevational view.

FIG. 5 is a top plane view.

FIG. 6 is a bottom plane view.

FIG. 7 is an enlarged view taken along line 7-7 in FIG. 2. This view is for clarity.

### DETAILED DESCRIPTION OF THE INVENTION

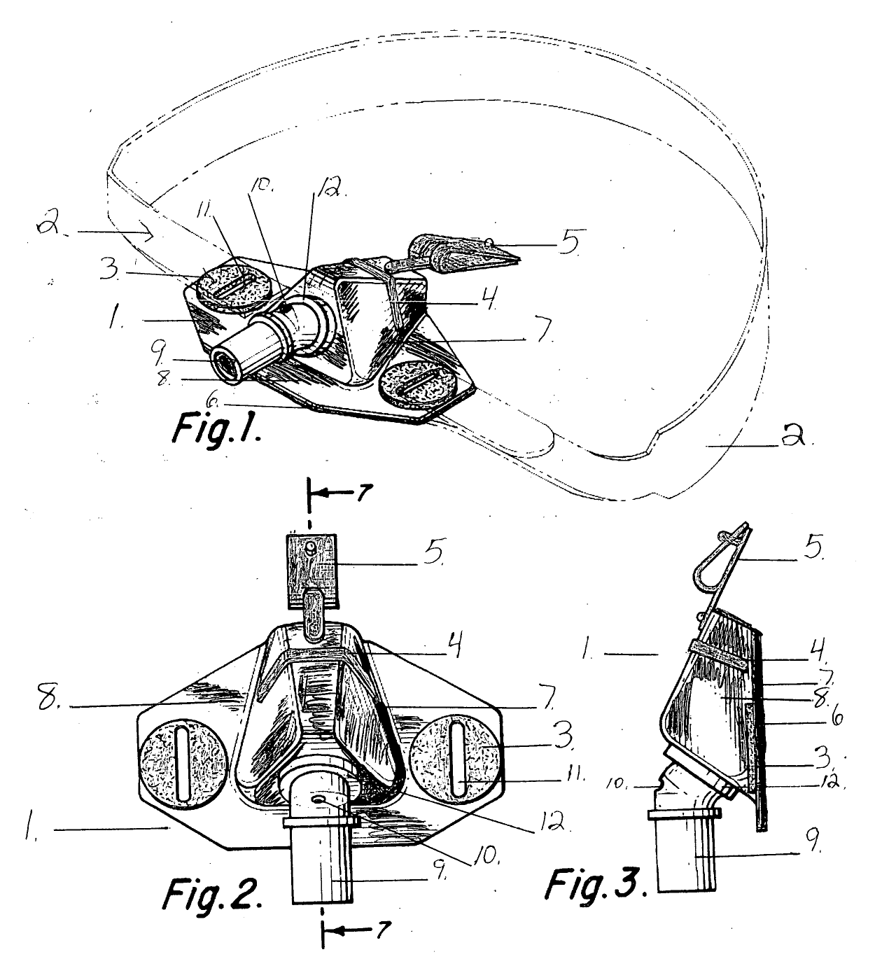

Referring to FIG. 1-3, the nose mask assembly (1) shown is an isometric view of the present invention. Visible in this view is the strap (2) that secures the mask around a nose area. Once fitted, the strap can be easily removed with the “Velcro” circular tabs (3) as viewed on both sides of the mask for fastening. These ‘Velcro” tabs can be used on either side of the mask, so the wearer can choose a dominating hand for quick release. The nose mask assembly includes a thin piece of aluminum (4) that lies across the upper part of the mask. This thin piece of aluminum allows a wearer the pinch the nose mask for a snug fit against a bridge of a nose. Fastened above the thin aluminum strip is an eye-glass clip. (5) This piece is removable from a mask. When attached, the eye-glass clip allows a wearer to attach their eye-glasses. (FIG. 1,6)(FIG. 5,8) The clip could attache to the mask by a buckle, or similar means to fasten the strap.(7) (FIG. 7) An annular swivel adaptor is shown and intended to attach to an airflow tubing assembly. The exhalation port is raindrop shaped.

Referring to FIG. 2, is a front elevational view of FIG. 1.

Referring to FIG. 3 is a right side elevational view of FIG. 1. The left side is identical.

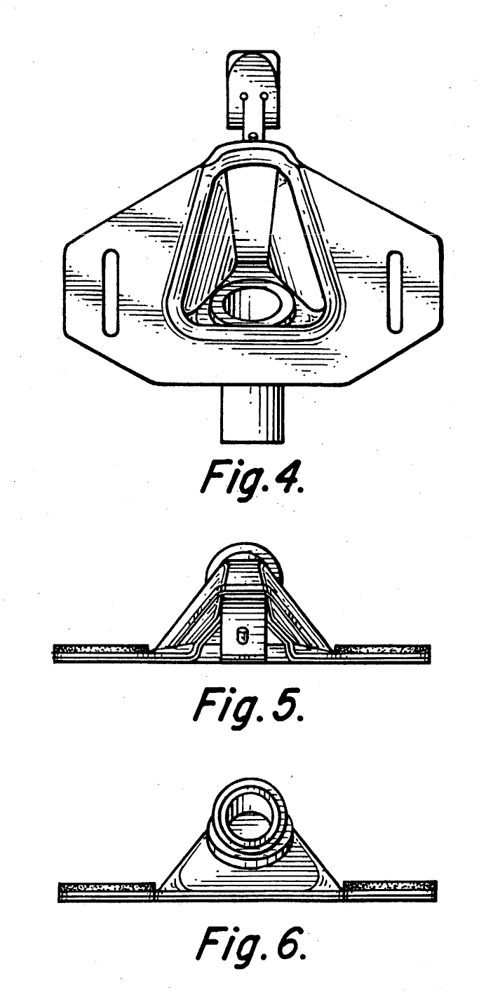

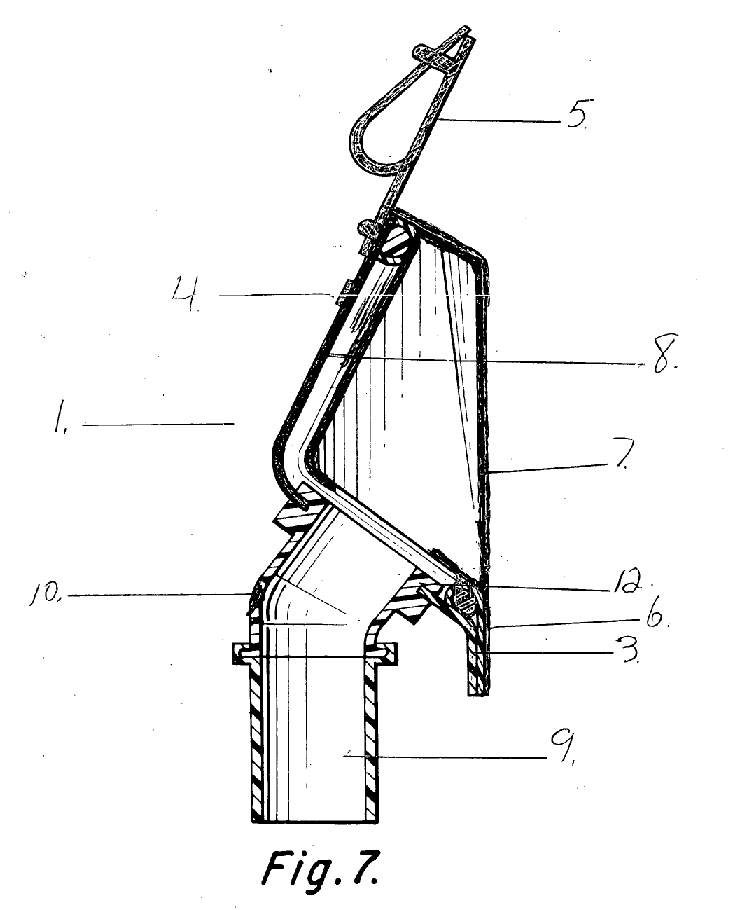

Referring to FIG. 4 is a rear elevational view of FIG. 1. The inner lining, (silicone wax lining) shown in this view, is intended to engage a wearer's face and contour and form to a face, as a seal.

Although not illustrated on a face, usage consists of customizing and applying a nose mask to a face of many individuals. The nose masks assembly contours and seals to fit each individual face.

Parts List

1. Nose Mask Assembly
2. Strap
3. Velcro Tabs
4. Aluminum Strip
5. Eyeglass (specticles) clip
6. Hypoallergetic thin membrane lining
7. Silicone wax lining material
8. Outer shell
9. Free moving gasket piece
10. Teardrop exhalation port
11. Slot
12. Port to attach swivel adaptor(free moving gasket)

1. I claim a nose breathing mask comprising of an outer shell ambient to air, inner towards face, covering a nose area and upper lip to form a seal. Inside a shell of a mask towards a patients' face is a silicone wax sealant. The silicone wax sealant is encased in a hypo-allergenic thin membrane. A removable eyeglass clip is available and resides on a part of the mask that rests on a bridge of a nose. A single strip of aluminum is directly below a eyeglasses clip and allows a more snug fit of a mask against a face, if so desired. A single strap goes across a cheek bone, under an ear, across an occipital to the other side of a face, under an ear and fastening to the opposing side of a mask. A swivel adaptor has been attached to provide a port for the oxygen, air source.

2. The outer shell of a mask comprising of a polyurethane substance of a shore of 60-70. The shore of a mask substance is critical to use for an apparatus because at this hardness a substance allows a shell to mold or contour to a patients' face.

3. Inside a shell of a mask towards a patients' face is a silicone wax lining that is on the inner rim of a shell and parameters to enclose a nose as a seal. The silicone wax is novel to the device because of its ability to retain the form it has been molded into. The silicone wax lining around a nose allows a patient form and contour a mask against a face to provide an air-tight seal. The silicone wax lining rests against a skin around a nose as well as rests against an upper lip. The silicone wax lining is a standard product currently available in retail stores for ear plugs.

4. The silicone wax lining is encased in a hypo-allergenic thin membrane backing wih a non-latex adhesive, protecting those with sensitive skin. This membrane is breathable allowing good oxygen and moisture vapor exchange. The membrane is waterproof and impermeable to liquids and bacteria. The hypo-allegenic membrane could be a substance by 3M known as ‘TEGADERM’. The encasing membrane is non-removable.

5. A removable eyeglass clip is an available option and is positioned on a part of a mask that rests on a bridge of a nose. A removable eyeglass clip is comprised of a substance like that of an outer shell of a mask. A substance is comprising of a polyurethane substance of a shore of 60-70.

6. A user is able to secure a mask to a head via a strap means that goes across a users' cheek bones and under a users ears to each side of a mask. A user attaches the strap to the opposite side of a mask via a hook and loop means such as ‘VELCRO’ A ‘VELCRO’ tab, which can be of any known shape but is shown in the drawings a a circular shape, on each side of a mask allows for ease of securing a strap to a mask. This versitality allows a user for either hand usage to attach a strap to a mask. A ‘VELCRO’ tab allows for easy removal and replacement of a mask. The strap constsits of a common material used by most CPAP masks. It could be a lycra-spandex mixture of fabric. The strap is unique by being a single strap contacting at olny two points on a mask.
